(19) United States
(12) Patent Application Publication
(10) Pub. No.: US 2015/0097086 A1
(43) Pub. Date: Apr. 9, 2015

(54) AIRBORNE WIND ENERGY CONVERSION SYSTEMS, DEVICES, AND METHODS

(71) Applicant: eWind Solutions, LLC, Beaverton, OR (US)

(72) Inventor: David Brian Schaefer, Wilsonville, OR (US)

(21) Appl. No.: 14/509,238

(22) Filed: Oct. 8, 2014

Related U.S. Application Data
(60) Provisional application No. 61/888,183, filed on Oct. 8, 2013.

(51) Int. Cl. G05D 1/00; B64C 39/02; F03D 9/00; B64C 9/00

(52) U.S. Cl. CPC G05D 1/00; B64C 9/00; B64C 39/02; F03D 9/002
USPC 244/175

(57) ABSTRACT

Wind energy conversion systems including an airborne wing, a tether, a generator, and a control system arranged to communicate with the airborne wing so that the control system directs the airborne wing to follow a predetermined flight path including a power generating phase. The predetermined flight path, during the power generating phase, includes a crosswind flight path of increasing altitude and a plurality of airborne wing turns, at each turn the airborne wing turn around an axis of the airborne wing, so that a vertical airspace for the predetermined flight path during the power generating phase is minimized.

### CROSS-REFERENCE TO RELATED APPLICATIONS

This application claims the benefit of U.S. Provisional Application Ser. No. 61/888,183, filed on Oct. 8, 2013, the disclosure of which is expressly incorporated herein by reference.

### BACKGROUND

The present disclosure relates to wind energy conversion systems, devices, and methods that generate energy during a crosswind power generating phase.

To take advantage of the greater force of winds available at higher altitudes, aerodynamic systems have been developed that work at altitudes above the heights reasonably reachable by ground-based wind turbines. Some of the existing aerodynamic systems use tethered devices to generate power by flying into the wind or by flying crosswind.

Devices that fly into the wind typically have flight controls for two axes, i.e., one axis for pitch and one axis for roll, to keep the main wing parallel to the ground while the tether is let out from a ground winching device at a controlled speed. The wind forces the wing upward creating a resulting force that is transmitted down the tether to a generator, to pump water, to turn a flywheel, or other energy conversion actions.

A crosswind motion of a wing is generally more efficient than a downwind motion because a crosswind motion allows the wing to fly many times the speed of the wind and harvest energy from an area that is many times larger than the area of the wing. When a wing moves in a plane normal to the wind vector during a crosswind motion, the apparent wind velocity becomes several times larger than the wind velocity itself. The crosswind motion generally results in higher forces generated in the tether compared to flying into the wind. However, crosswind devices also require more complex control systems than into the wind systems. Crosswind devices typically require controls for three axes, i.e., pitch, roll, and yaw, to follow a more complex fight pattern, such as a circular or FIG. 8 pattern, during the energy generating portion of the flight path.

Known devices that use crosswind motion to increase the force in the tether are described, for example, in U.S. Pat. No. 3,987,987, and in an article by Miles L. Loyd “Crosswind Kite Power,” published in the Journal of Energy, Vol. 4, No. 3. May-June 1980. Other variations of crosswind systems with a generator on the ground have been suggested. For example, U.S. Pat. No. 6,072,245 describes multiple airfoils that are connected to a single generator. The complete disclosures of the above patents are herein incorporated by reference for all purposes.

However, the known wind energy conversion systems and devices are not entirely satisfactory for the range of applications in which they are employed. For example, the existing systems require a large turn radius for a device when flying crosswind, cannot adjust the nominal tether angle and cannot optimize the flight path for a given height or width operating restriction.

Thus, there exists a need for airborne wind energy conversion systems, devices and methods that improve upon and advance the design of known systems.

### SUMMARY

The present disclosure is directed to wind energy conversion systems including an airborne wing, a tether, a generator, and a control system arranged to communicate with the airborne wing so that the control system directs the airborne wing to follow a predetermined flight path including a power generating phase. The predetermined flight path, during the power generating phase, includes a crosswind flight path of increasing altitude and a plurality of airborne wing turns, at each turn the airborne wing flips around an axis of the airborne wing, so that a vertical airspace for the predetermined flight path during the power generating phase is minimized.

In some examples, the airborne wing includes a portion facing the tether and a portion facing away from the tether, and at each turn the airborne wing flips around an axis so that the portion facing the tether before a turn faces away from the tether after the turn and the portion facing away from the tether before the turn faces the tether after the turn.

The present disclosure is further directed to aerodynamic devices, including a body with a frame and with two or more side wings coupled to the frame, and further including a coupling mechanism coupled to the body and arranged to couple the body to a tether. The body is adapted to perform a flight path including a plurality of turns so that at each turn the body rotates about 180 degrees around an axis, such as a pitch axis of the body, and the coupling mechanism allowing the body to rotate freely relative to the tether.

The inventive subject matter further contemplates an aerodynamic device including a body including a frame and two or more side wings coupled to the frame, a coupling mechanism coupled to the body and arranged to couple the body to a tether, and two or more rudders arranged to generate lift away or towards the ground and configured such that a total lift of the rudders adjusts a flight path of the device by changing a nominal tether angle during a crosswind power generating phase.

This Summary is not intended to limit the scope or meaning of the disclosed subject matter. Further, the Summary is not intended to identify key features or essential features of the disclosed subject matter, nor is it intended to be used as an aid in determining the scope of the disclosed subject matter.

### BRIEF DESCRIPTION OF THE DRAWINGS

FIG. 1 is a simplified perspective view of a first example of an airborne wind energy conversion system.

FIG. 2 is a perspective view of an airborne wind energy conversion device, as used in the system of FIG. 1.

FIG. 3 is a simplified perspective view illustrating a flight path of the system of FIG. 1.

FIG. 4 is a simplified side view of the airborne wind energy conversion system of FIG. 1.

FIG. 5 is a simplified side view illustrating different phases of a flight path of an airborne wind energy conversion system.

FIG. 6 is a perspective view of a second example of an airborne wing including a loop element.

FIG. 7 s a perspective view from the back of a third example of an airborne wing including a uniform front wing.

FIG. 8 is a graph illustrating average power produced during different phases of an energy conversion cycle with a disclosed wind energy conversion systems having a wingspan of about 80 feet.

FIG. 9 is a simplified side view of an example of a wind farm incorporating airborne wind conversion systems according to the inventive subject matter.

FIG. 10 is a top view illustrating another example of a flight path of a device according to the inventive subject matter.

### DETAILED DESCRIPTION

The disclosed airborne wind energy conversion systems, devices, and methods will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein.

Throughout the following detailed description, examples of various airborne wind energy conversion systems, devices, and methods are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

The inventive subject matter is directed to a wind energy conversion system including an airborne wing, a tether, a generator, and a control system arranged to communicate with the airborne wing. The control system directs the airborne wing to follow a predetermined flight path that includes a power generating phase. The airborne wing increases in altitude during the power generating phase by following a crosswind flight path that includes a plurality of airborne wing turns wherein at each turn the airborne wing flips around an axis of the airborne wing, for example around a pitch axis of the airborne wing, around a roll axis of the airborne wing, or around a yaw axis of the airborne wing, or at an angle relative to one or more of those axes. In some embodiments, the airborne wing turns about 180 degrees around an axis of the airborne wing that is substantially perpendicular to a direction of flight of the airborne wing and substantially perpendicular to the tether, in particular by turning over completely around the pitch axis of the airborne wing.

As used herein, a “crosswind flight path” refers generally to a path followed by an airborne wing wherein the wind blows in a direction that is generally not parallel to the course followed by the airborne wing. In the disclosed embodiments, the airborne wings follows a crosswind flight path wherein the altitude of the airborne wing generally increases. The term “airborne wing” and “aerodynamic device” are used herein interchangeably.

In some embodiments, the crosswind flight path follows a zigzag pattern during a power generating phase, also referred to as crosswind power generating mode or crosswind power generating phase. At a turn in the zigzag pattern, the airborne wing turns about 180 degrees relative to the tether so that a portion of the airborne wing facing the tether before a turn, faces away from the tether after the turn, and a portion of the airborne wing facing away from the tether before the turn, faces the tether after the turn. At a subsequent turn, the airborne wing repeats the turn maneuver in the opposite direction. Alternating the direction of turning of the airborne wing during the flight path results in a zigzag flight pattern. In the crosswind power generating mode, between turns, the airborne wing increases in height. During this phase, most of the power is generated by the airborne wind energy device while the front and rear main wings are at a positive angle of attack to the relative wind. At such a positive angle of attack, the leading edge of the chord line of a symmetrical wing, for example, is above the line representing the relative wind and such a positive angle of attack causes the airborne wing to produce tension in the tether.

During a crosswind power generating phase, a complete turn-over of the body of the airborne wing minimizes the turn radius of the disclosed device at each turn and thus minimizes the vertical airspace required for performing that turn for a device with a given wingspan, and also minimizes the vertical airspace used by the airborne wing for the entire crosswind flight path during the power generating phase.

In some embodiments, a complete turn-over of the body of the airborne wing around an axis, for example the pitch axis and tether attachment point, is accomplished by turning the entire back side wing(s) in a direction opposite the turning of the entire front side wing(s). In that case, turning the entire lifting surface not only minimizes the turn radius, but also prevents loss of angular momentum, and reduces time in a low energy production mode at each turn.

In other example embodiments, a complete turn-over of the body of the airborne wing around an axis is accomplished by turning one or more control surfaces on back side wing(s) in a direction opposite the turning of one or more control surfaces on front wing(s). In further embodiments, a turn-over around an axis may be accomplished by pivoting front and/or back side wings.

Some embodiments of the inventive subject matter are directed to aerodynamic devices, such as an airborne wing, kite, or other wind engaging member. The aerodynamic device is generally shaped to maximize a lift to drag ratio. The device includes a body having a frame and two or more side wings, a coupling mechanism, and a control system. The coupling mechanism is coupled to the body and is arranged to couple the device to a tether. The body and wings are arranged so that the aerodynamic device can flip around an axis of the device, for example a pitch axis and perform a zigzag pattern with alternating sides of the body and wings facing the tether. The device maneuvers mainly in a crosswind mode, except during take-off and landing, and a glide back mode where it is into the wind, as explained further below.

Directional terms such as “top”, “bottom”, “upper”, “lower”, “vertical” and “horizontal” are used in the following description for the purpose of providing relative reference only, and are not intended to suggest any limitations on how any apparatus is to be positioned during use, or to be mounted in an assembly or relative to an environment.

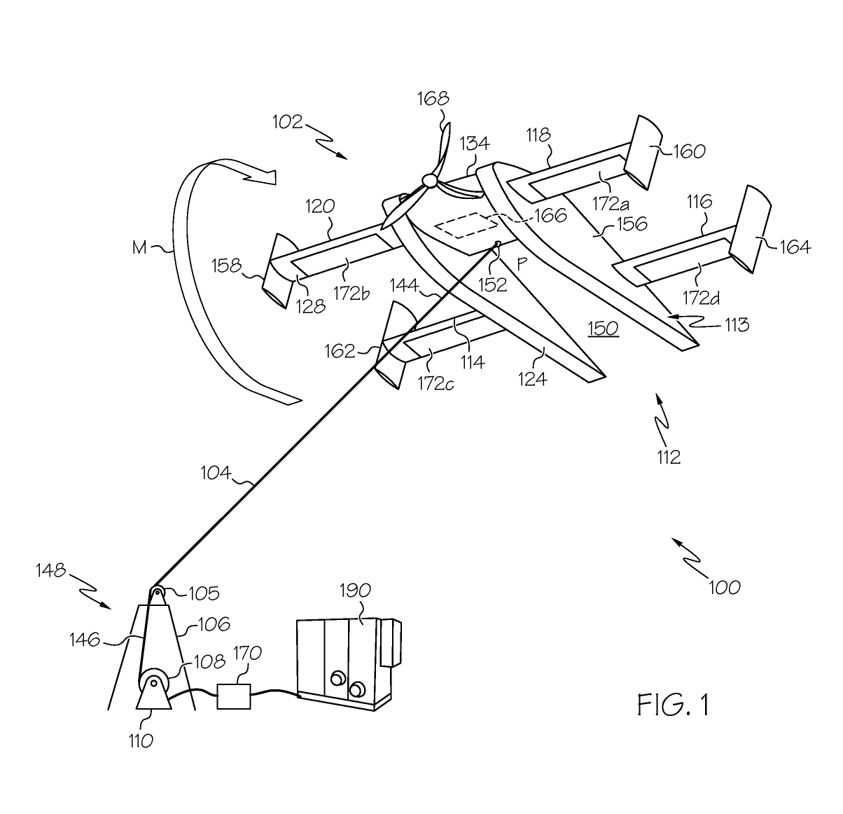

With reference to FIGS. 1-4 a first example of an airborne wind energy conversion system and device, will now be described. Airborne wind energy conversion system 100 has an aerodynamic device such as airborne wing 102, a tether 104, a tower 106, a winching device 108, and a generator 110. The system also has a power inverter and energy storage system 190.

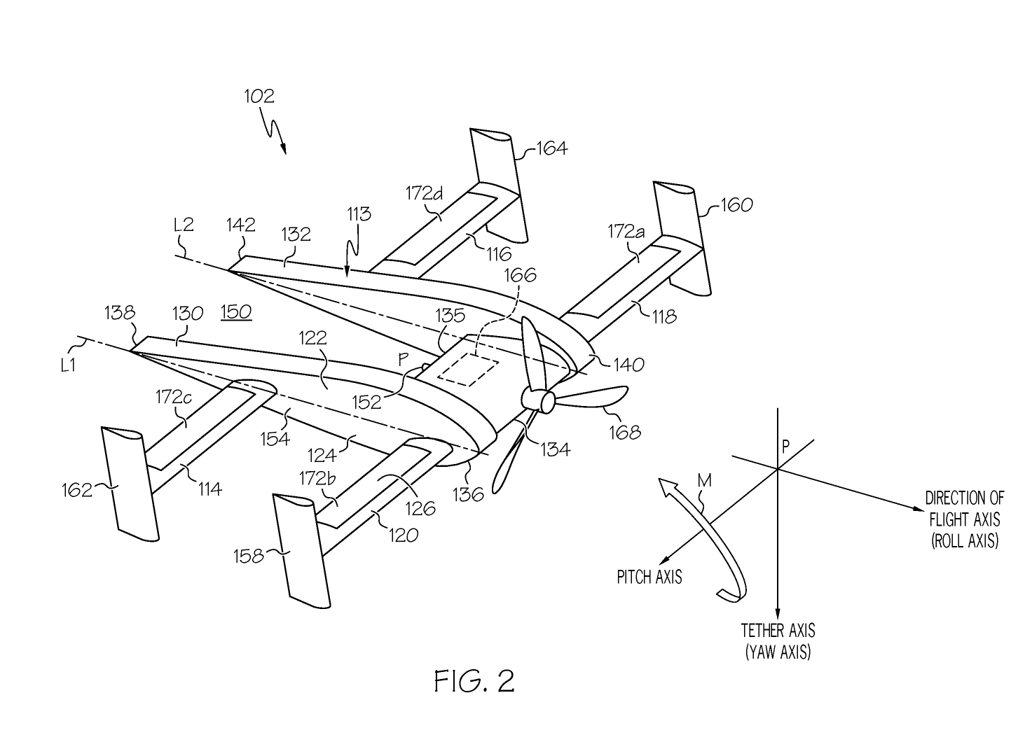

Airborne wing 102 includes a body 112 having a frame 113 and four side wings 114, 116, 118, and 120 coupled to frame 113. Frame 113 has a top portion 122 and a bottom portion 124 that are substantially mirror images of each other along a longitudinal plane through the center of body 112, that is a plane through center lines L1 and L2 of arms 130 and 132 as marked in FIG. 2. Each side wing 114, 116, 118, and 120 has a top portion 126 and a bottom portion 128. In the embodiment shown, top portion 126 and bottom portion 128 are substantially minor images of each other, for example as in the case of a symmetrical airfoil. As shown in FIG. 1, bottom portion 124 of frame 113 and bottom portions 128 of each side wing face tether 104 while the respective top portions face away from tether 104. It is understood that FIG. 1 is a simplified view and not to scale.

Frame 113 has two arms 130 and 132 coupled to each other via a connecting portion 134. Arms 130 and 132 are right and left versions of similar shape. Each of arms 130 and 132 has the shape of a substantially symmetrical airfoil. Arm 130 has a leading edge 136 at the front of airborne wing 102 and a trailing edge 138 at the back of airborne wing 102. Arm 132 has a leading edge 140 and a trailing edge 142.

Connecting portion 134 has the shape of a substantially symmetrical airfoil with a length that is less than half the length of the arms, for example connecting portion 134 may have a length that is about 1/4 of the length of arms 130 and 132. Connecting portion 134 is attached to arms 130 and 132 towards leading edges 136 and 140, with the airfoil profile lining up with the airfoil profile of the arms.

The opening formed between the trailing edge 135 of connecting portion 134 and arms 130 and 132 forms a passageway 150 for tether 104 to pass when the device flips, that is when the device rotates about 180 degrees around an axis, such as the pitch axis, the device completely turns over around tether attachment point P, and continues its flight path in an opposite direction. This embodiment is also referred to as an “open tail design” or a “split tail design.” Arrow M in FIGS. 1-2 illustrates a direction in which airborne wing 102 will perform its next turn in a crosswind power generating phase. After the turn, airborne wing 102 proceeds with a power generating path in an opposite direction until a subsequent turn is performed.

Side wings 114, 116, 118, and 120 are attached to sides 154 and 156 of frame 113. Generally, a wing on one side of the frame has a complementary wing at a corresponding location on the other side of the frame. For example, back wing 114 is generally aligned with back wing 116, and front wing 118 is generally aligned with front wing 120. In the longitudinal direction, back wing 114 is aligned with front wing 120, and back wing 116 is aligned with front wing 118. In other embodiments, there may be an offset between the alignment of front wings and back wings, for example, to avoid the air turbulence coming off the trailing edge of the front wing from running into the lead edge of the rear wing. In some embodiments, side wings may be shaped as common symmetrical airfoils wherein height and width of the wing is determined by the kind of airfoil.

Generally, aerodynamic lift of an airborne device and its carrying capacity are determined by dimensions of a wingspan and chord of the device. Wingspan dimensions, however, are typically limited by the materials used for construction of the wingspan, strength of the construction, and weight of the construction. Height is typically minimized to reduce aerodynamic drag but is also limited by current material construction, strength and weight.

In some embodiments, the length of the aerodynamic device is approximately equal to the wingspan. For example, an airborne wing may have a wingspan of about 10 feet, a total length of about 10 feet, a height of about 1 foot at a largest cross section of the body and a few inches at the body's smallest cross section, and one or more rudders of at least about 2 feet high. In other embodiments, an airborne device may have a wingspan of about 100 feet or more. Dimensions are given for illustrative purposes and are not intended to be limiting in any way.

Airborne wing 102 is formed as a generally rigid wing structure, for example made of carbon fiber like a wing of a plane. In other embodiments, the aerodynamic device can be made of any of the following: a flexible wing (like many kite wings); a soft wing (like a sailboat's sail); an inflatable wing; an inflatable wing, inflated by the ram air, entering it through holes; a kite wing; a paraglider wing; a wing, using soft materials, spread over a rigid frame or cables; a wing made of elastic fabric, receiving airfoil form from relative air flow; and/or a mixed wing, using different construction techniques in different parts of the wing. In further embodiments, an airborne wing may be designed to accomplish a lift to drag ratio (L/D) larger than 10 at a specific angle of attack. Optionally, the airborne wing may be provided with wheels for landing and take-off.

Examples of other suitable construction materials for the airborne wing include fiberglass, wood, aluminum, aramids, para-aramids, polyester, high molecular weight polyethylene, nylon and others. Wing 102 can include various planforms, for example a straight wing, swept wing, delta wing, or a wing tapering to the ends in chord or thickness or both. In some embodiments, an airborne wing may be provided with coatings, for example coatings resisting water impregnation, adhesion from snowfall, UV resistant coating, or radar absorbent material.

The wind energy conversion system further includes a control system arranged to communicate with the airborne wing. The control system ensures stable and coordinated movement of the airborne wing. The control system may be an autonomous onboard control system that is integrated in the airborne wing, for example an onboard control system that is in constant communication with a ground control system or a remote control system, or a control system that remotely directs movement of specific control surfaces of the device.

In some embodiments, multiple control systems may be responsible for general operation of the airborne wing and transmitting commands to the airborne wing. For example, a control system for each side wing may be responsible for generating commands to each actuator of the wing, while another control system may transmit data from its sensors to a remote control system.

In some embodiments, a control system may include a plurality of subunits, either onboard or remote, that collaborate to direct the airborne wing through wind energy conversion cycles and related maneuvers. In another example embodiment, several control systems may communicate with each other to coordinate flight paths and related maneuvers of multiple aerodynamic devices, for example as used in a wind farm.

FIGS. 1 and 2 show an onboard control system 166 that directs the airborne wing to follow a predetermined flight path adjusting to changing wind and performing required maneuvers, such as following a zigzag pattern and flipping of the airborne wing at turns in the flight path. Control system 166 also communicates with a ground control system 170 directing a uniform release speed of the tether during a power generating phase. Control system 166 communicates with specific control surfaces of airborne wing 102, for example, with control surfaces 172a-d in the form of vertical stabilizers, rudders, ailerons on side wings and/or on rudders of the airborne wing, to perform a rotation of the airborne wing around an axis and around tether attachment point P. Control surfaces may be installed, for example, at the trailing end of the wings, arms, connection portion, or at various other locations.

In some embodiments, control system 166 directs turning of the entire back wings, for example back side wings 114 and 116, in a direction opposite to the turning of the entire front side wings, for example front side wings 118 and 120, to accomplish a turn during the power generating phase. In that case, side wings 114, 116, 118, and 120 are pivotably coupled to frame 113 and may turn about 12 degrees or less relative to frame 113.

In other embodiments, control system 166 directs turning of airborne wing 102 through the use of flight control surfaces. Front and rear control surfaces, for example control surfaces 172a and 172b, may be used to turn airborne wing 102 in an opposite direction around a roll or pitch axis and tether attachment point P. Control surfaces 172c and 172d, such as up and down movable portions of back wings 114 and 116, may be tilted, at an angle of about 12 degrees or less relative to the side wings, in a direction opposite the turning of front wing control surfaces, for example control surfaces 172a and 172b of front side wings 118 and 120. Control surfaces 172a-d on front and rear symmetrical side wings form the majority of the lift area of side wings 114, 116, 118, and 120. They provide lift that is larger than the lift area of traditional commercial aircraft ailerons compared to the overall main wing lift area. Control surfaces 172a-d turn toward a top portion 122 and/or towards a bottom portion 124 of body 112. During the turn, control surfaces on front and rear side wings turn in opposite directions.

Control system 166 may include a central processor or a microcontroller, sensors, actuators for rudders and ailerons, communication means for communication with the ground, and an energy source. Communication means may include a wireless network or communication wires accompanying the tether. Ground sensors may include an anemometer, barometer, radar, hygrometer, thermometer, GPS, cable tension meter, RPM meter, cameras for observing the wing and other. In some embodiments, one control system can serve multiple ground stations and wings. Optionally, a control system can be connected to the Internet to receive general weather information, for example warnings of extreme weather events. Sensors may include a speed meter, altimeter, accelerometer, gyroscopic sensor, GPS, stall warning device, compass, cameras, and other. The energy source can be, for example, a battery or a small turbine, working from air flow, such as propeller 168.

Propeller 168 serves a dual purpose. It is being used for take-off/landing and on-board energy generation for the flight control system, aircraft lighting, and aircraft-like transponder system. For example, propeller 168 may be powered via on-board batteries for take-off and landing. In some embodiments, two counter rotating propellers may be used to balance torque around the roll axis.

Aerodynamic device 102 also includes two or more rudders configured such that the total lift of the rudders adjusts the flight path of the device. In some embodiments, the total lift of the rudders adjusts the flight path of the device by increasing or decreasing a nominal tether angle during a crosswind power generating phase and generates lift away from or towards the ground as required when the front rudders, for example rudders 158 and 160 shown in FIGS. 1 and 2, and rear rudders, for example rudders 162 and 164 shown in FIGS. 1 and 2, are turned in approximately the same direction around the yaw axis. In such an embodiment, the total lift from the front and rear rudders is approximately balanced around the tether attachment point in the yaw axis.

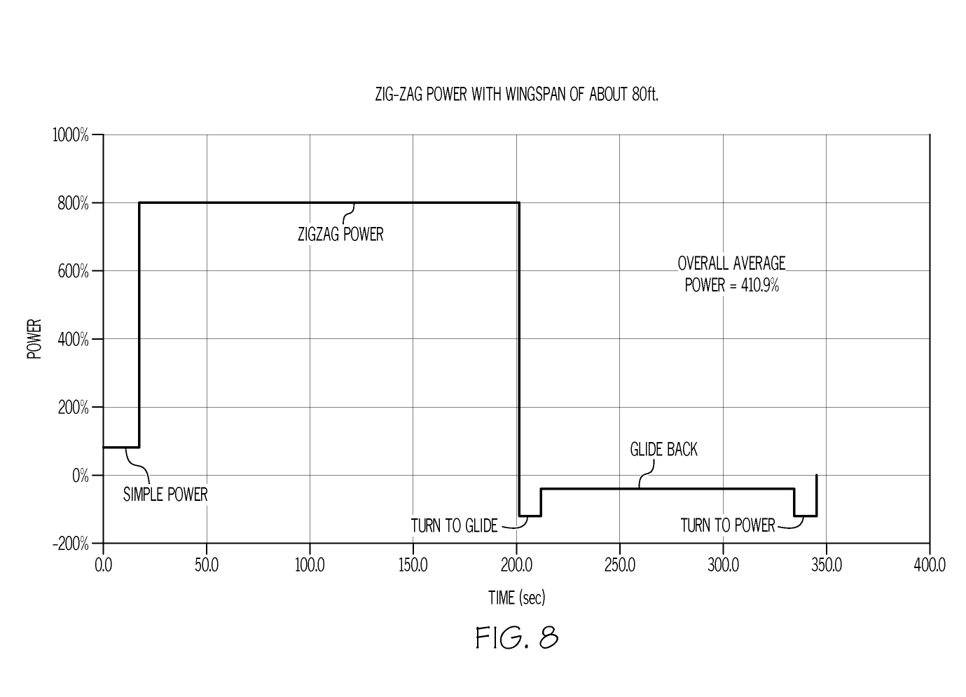

In another embodiment, the rudders can be configured such that the total lift of the rudders increases or decreases the turn radius of the device around the yaw axis, when utilized during a crosswind power generating phase, for example when following a FIG. 8 or circular flight path. In that case the front rudders, such as rudders 158 and 160, and rear rudders, such as rudders 162 and 164, are turned in approximately equal and opposite directions around the yaw axis. In this embodiment, the total lift from the front and rear rudders is not balanced around the tether attachment point in the yaw axis and the resulting moment around the yaw axis increases or decreases the aerodynamic device turn radius around the yaw axis (and reduces the sideways slip as would be encountered for example in a commercial airplane which do not have front rudders and which need to turn slightly inward around the roll axis in addition to turning the rudder to initiate a yaw turn). The rudders could utilize a symmetrical or unsymmetrical airfoil.

In further embodiments, the tops of the rudders are angled outwards up to 50 degrees around the roll axis relative to the side wings in a V-tail configuration. In this configuration, additional lift is generated during launching of the aerodynamic device off the tower as the vertical rudder configuration shown provides no additional lift area during launch. In the case of four rudders configured in a V-tail arrangement, the rudders also provide control surfaces around the pitch, roll and yaw axis. For example, four rudders 158, 160, 162, and 164 at the end of the side wings 120, 118, 114 and 116 respectively, turn around the yaw axis relative to the side wings at approximately +/−12 degrees. Rudders 158, 160, 162, and 164 are controlled by control system 166 and assist in orientation of the airborne wing during the power generating phase by generating a lift force that increases or decreases a nominal tether angle, i.e., providing lift to the airborne wing generally perpendicular to the tether in the vertical orientation shown in FIG. 2, either towards or away from the ground.

In some embodiments, rudders may be positioned in one orientation during the power generating phase and remain in that position during the power generating phase, such that they generate a lift force (rudder lift is generally normal to the tether and directed either upwards or downwards) which increases or decreases the nominal tether angle and reduces the projected land usage below.

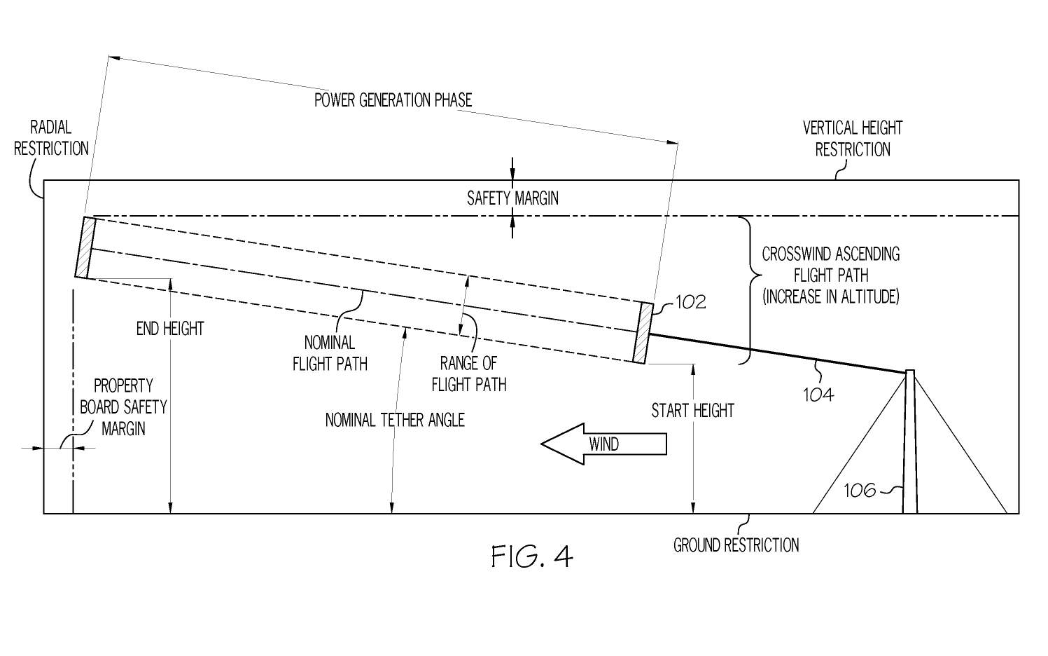

For example, with reference to FIG. 4, rudders 158, 160, 162 and 164 can be utilized to adjust the nominal tether angle and reduce the range of flight path in a zigzag, FIG. 8 or circular flight pattern to maximize the crosswind power generating range if the location has either a ground, height, or radial restriction. An example of a ground restriction can be a building, changes in ground terrain, another airborne energy system tower, or similar. The height restriction may be a restriction such as set by the Federal Aviation Association (FAA), for example in Code of Federal Regulations Title 14 Part 77, with a limit of 499 feet above ground level, or other similar safety airspace restrictions. A radial restriction could be setbacks to public highways, railroads, and other limits as defined by the FAA or neighboring property borders. An increase of the nominal tether angle by for example approximately 10 degrees during initial launch enables an earlier start of the crosswind power generation phase, and a decrease of the angle of about 10 degrees at the end of the power generation phase enables a later finish, both of which result in a longer power generation phase. With a restriction of 499 feet above ground level, a decrease of the tether angle of about 10 degrees, such as from about 30 to about 20 degrees, the power generation phase extends by 46% for the disclosed systems.

Additionally, decreasing a range of flight path by decreasing the device's turn radius also increases the crosswind power generation phase. As another example, to optimize the power generation from a particular operating site that has both a radial restriction and a height restriction, the nominal tether angle can be adjusted such that the end of the power generating phase intersects the corner of the radial restriction and the height restriction, or the nominal angle of the tether can be set to take tradeoff consideration between the two restrictions into account.

In embodiments with a stationary rudder position, the rudder reduces the power required from the onboard control system to guide the wing through a zigzag pattern, versus the power required from the onboard control system to accomplish a FIG. 8 or circular pattern which is typically achieved through yaw and roll control requiring constant adjustments of the rudder angle. In other embodiments, at least two rudders may be adjustable to alter the flight path of the device and to increase a nominal tether angle.

The size and position of front rudders, such as rudders 158 and 160 and back rudders, such as rudders 162 and 164, are such that the resulting lift and drag moments plus the aerodynamic device's weight moment are balanced around tether attachment point P in the yaw axis. During a crosswind power generating phase, both the front and rear rudders have a positive angle of attack if the rudder airfoils are symmetrical. If the rudder airfoils are non-symmetrical, the airfoils are orientated such that all rudder surfaces produce lift in the same direction, either towards or away from the ground, such that the nominal tether angle is decreased or increased. In some embodiments, rudders may be coupled to the main body. In other embodiments, rudders may be integrated in the side wings. Rudders are generally sized, and the angle of attack adjusted to maximize the lift to drag ratio such that the resulting lift and drag moments of the rudders, plus the device's weight moment around the tether attachment point, are balanced around the yaw axis of the aerodynamic device in the crosswind power generating phase. The rudders are adapted to direct the device to follow a flight path having a range of flight that is smaller than that of conventional devices. For example, adjustments of the rudders allow the aerodynamic device to accomplish a turn radius that is smaller than about six times the predetermined wingspan, as would be the case for conventional devices performing a FIG. 8 pattern.

Optionally, the airborne wing may have a specific design of wingtips, with or without rudders, to decrease turbulence and noise.

Wind energy conversion system 100 also includes a tether, such as tether 104. Tether 104 has an upper end 144 coupled to airborne wing 102 at a tether attachment point P, for example via a load cell and an universal coupling, and a lower end 146 coupled to winching device 108, for example a rotating drum or a capstan, at a ground station 148. Tether 104, for example a suitable cable, has a length sufficient to allow the airborne wing to reach a desired maximum predetermined height, for example a length sufficient for a device to reach not farther than a height limit set by the FAA, at a desired operating angle of the nominal tether. In some embodiments, a tether, such as a Dyneema® tether, may have a length of about 900 feet for an airborne wing with a wingspan of 80 feet, a wing aspect ratio of 2, and a diameter of 1.4 inches based on a desired safety factor of 2 in a strong crosswind.

Tether 104 can be made of a material and construction that allows interactions with the winching device, and that has strength to withstand forces produced. Additionally, tether material may be UV resistant and water resistant. For example a tether can be made of suitable materials such as Dyneema®, Kevlar™, Vectran®, Zylon®, and the like.

FIG. 1 shows an upper end 144 of tether 104 that is arranged to allow coupling of tether 104 to a coupling mechanism 152 at a central location of the body 112 that is near a center of aerodynamic lift and near a center of gravity of the device so that a free rotation of the body relative to the upper end of the tether is allowed. As shown in FIGS. 1 and 2, coupling mechanism 152 is coupled to connecting portion 134 of body 112 at a midpoint location along the width of connecting portion 134. Coupling mechanism 152 may include, for example, a swivel coupling provided with a load sensor.

Lower end 146 of tether 104 is coupled to a winching device 108, for example a drum that transfers rotation to a generator. Winching device 108 can be any mechanical device that is used to pull in (wind up) or let out (wind out) or otherwise adjust the tension of tether 104.

During a power generating phase, tether 104 unwinds from winching device 108 while rotating the winching device with force. During a glide back phase, winching device 108 can rotate in the opposite direction pulling tether 104 in and causing it to wind around the winching device, for example like a spool. Examples of suitable winching devices may include a rotating drum, a capstan, a gear assembly, or other suitable device that is used to pull in or let out or otherwise tension the tether. In some embodiments, the winching device axis may be vertical. Other embodiments may include winching devices having a horizontal axis, or a combination of devices that are collaborating together to tension the tether. In an exemplary embodiment, a drum may have diameter large enough to keep mechanical stress in the tether below a material yield strength limit with a safety and keep the heat buildup in the tether below the tether material's operating range.

FIG. 1 shows an electrical generator 110 located on the ground (or around the ground). In other embodiments, a generator may be above a water surface, for example in the case of marine deployment. In some embodiments, a generator may be incorporated in a tower. In further embodiments, on-site energy storage may be provided, for example in a battery, flywheel, or as compressed air. In further embodiments, the system may convert the motion energy provided by the tether to other forms of energy such pumping water, turning a flywheel, or convert sea water to hydrogen.

As shown in FIG. 1, generator 110 is coupled to winching device 108, for example a mechanical connection including a transmission which couples the winching device to a rotor of the generator, as known in the art.

Wind energy conversion system 100 further may have a ground station, such as ground station 148 including a structure that guides tether 104 to winching device 108, for example, via a retaining ring, a hollow shaft, or an assembly of pulleys. Airborne wing 102, has the ability to produce varying tether tension as a result of aerodynamic forces. At ground station 148, tether 104 is coupled, via winching device 108 to electrical generator 110 that forms part of ground station 148. When airborne wing 102 is travelling along a flight path, tether 104 unspools from winching device 108, consequently transferring mechanical energy to the electrical generator. The features of ground station 148 may depend on the terrain wherein the system is deployed, for example a ground station may be set up differently in a relatively flat terrain versus an area with rolling hills.

Optionally, system 100 may include a tower. For example, tether 104 may be guided over a guide wheel 105 coupled to tower 106. The tower may provide stability and protection to the system. Tower 106 may also include a land/release platform, for example to launch the wing slightly away from ground air turbulence caused by obstacles such as trees, rocks, hills, and the like. In some example embodiments, a tower may have a height corresponding to about half of a device's wingspan plus a ground clearance safety margin for the airborne wing, for example a height of about 25 feet for a wing of about 30 feet. In other embodiments, the tower may be collapsible. A tower also provides protection from vandalism, provides protection to ground personnel, and prevents damage to the wing tips with minor tilting of the “parked” wing because the tips would not hit the ground.

To produce useful work, airborne wing 102 is flown at a relatively low angle, for example between about 20 degrees and about 50 degrees, downwind of ground station 148. High airspeed over the body's surface of the aerodynamic device creates a force that pulls on tether 104. Tether 104 is let out by ground station 148 at a rate dependent on the absolute magnitude of the wind speed and the physical limitations of generator 110.

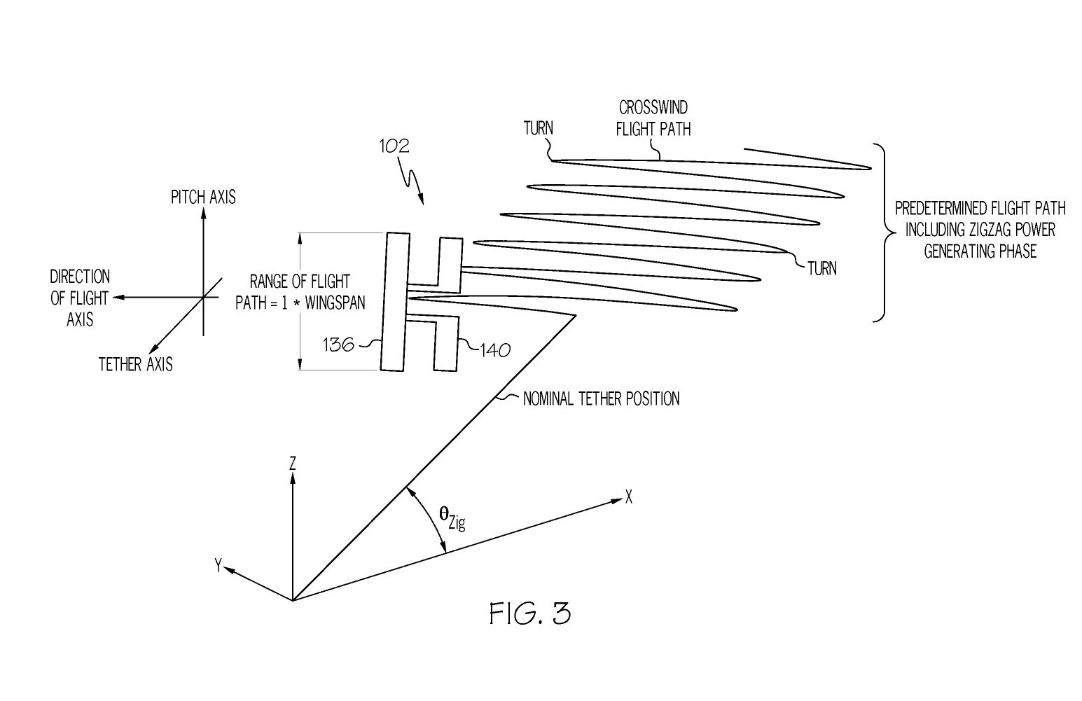

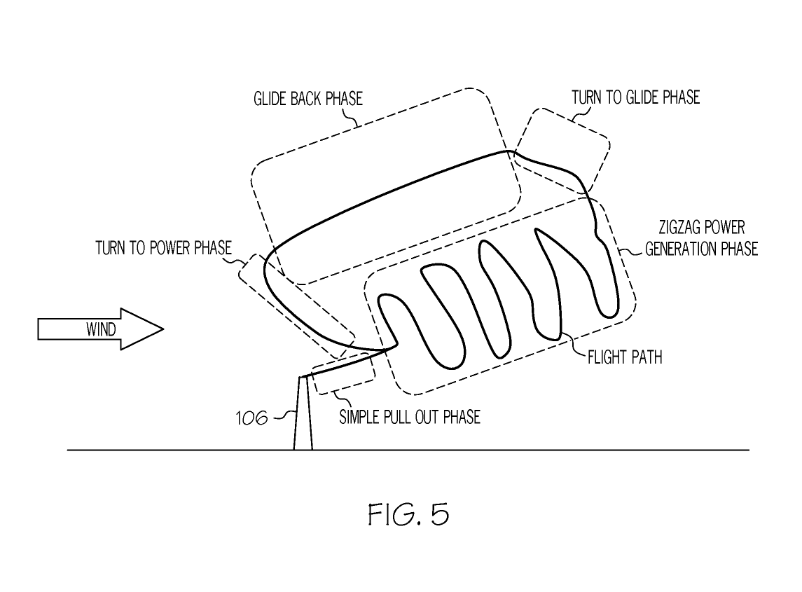

FIGS. 3, 4, and 5 illustrate examples of a predetermined flight path including different phases in a wind energy conversion cycle. To assist the reader in visualizing the flight path, the flight path of the ZigZag Power Generating Phase, shown in FIG. 5 is rotated 90 degrees on the figure compared to an actual flight path of a device during a power generating phase. To correspond with other features shown, an actual flight path during the power generating phase of a device would go back and forth into the page. As used herein the term “flight path” refers to the actual or planned course that the aerodynamic device follows during a specific phase of a wind energy conversion cycle. The flight path changes during the wind energy conversion cycle. A device according to the inventive subject matter follows a flight path that increases in height during a power generating phase. For example, as shown in FIG. 4, an aerodynamic device 102 may start its flight path at a ground safety margin. During the flight the height increases along a nominal flight path, and ends at a safety margin below a maximum height, such as a maximum height limit of 499 feet above the surface of the earth set by the FAA.

FIGS. 3 and 4 also illustrate how airborne wing 102 follows a flight path of increasing altitude during a power generating phase while following a zigzag pattern and while also increasing a horizontal distance from the tower. During a glide-back phase the device proceeds with its wings substantially parallel to the ground. At the end of the glide back phase, the device turns back 90 degrees to start a new power generating phase. The horizontal distance between the device and the tower is larger at an end point of the power generating phase compared to a position of the device at a start point of the power generating phase.

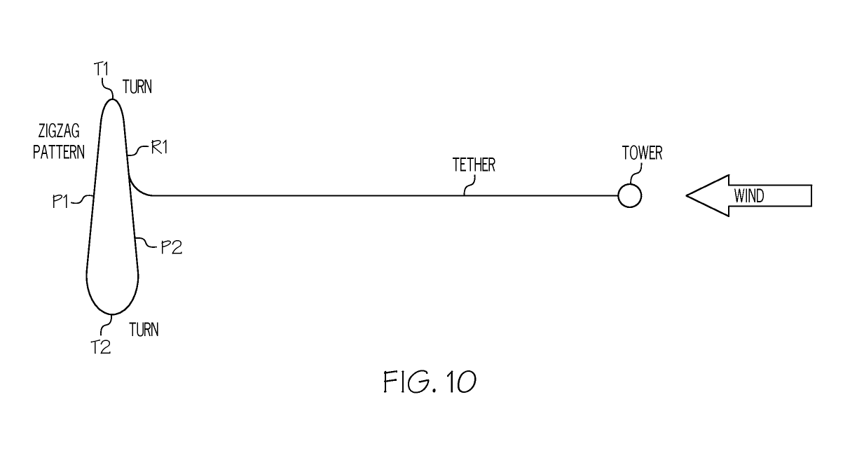

FIG. 10 is a top view illustrating another implementation of a system including a zigzag pattern according to the inventive subject matter. An aerodynamic device follows a zigzag patterned flight path during a power generating phase whereby the device increases in altitude following a zigzag pattern. However, in this embodiment, a glide back phase and a 90 degree roll turn in the turn-to-glide and turn-to-power phase are eliminated. The side wings on the aerodynamic device remain substantially perpendicular to the tether and to the ground, except when the device needs to return to the tower where it glides back. The power generating phase includes only one loop that is repeated over and over again. Thus, FIG. 10 may be seen as a shortened version of the flight path shown in FIG. 3 in that it only contains the last cycle of zigzag travel which includes one crosswind (downwind) motion to the right (R1), a turn (T1) in the wind direction away from the tower, one cross wing motion to the left (downwind) (P1), a turn (T2) into the wind (upwind) and glide back (into the wind) (P2) to start the process over again. The reverse direction is also possible. This cycle is performed at the highest altitude where the highest wind speeds are found. The horizontal distance between the tower and a position of the aerodynamic device at the start of the power generating phase does not change significantly compared to the horizontal distance between the tower and a position of the aerodynamic device at the end of the power generating phase. In other words, the device may follow a flight path including one or more loops that increase along a vertical axis (increase in altitude), but where there is no significant increase along a horizontal axis for subsequent loops. It is understood that the tether is released when the height of the device increases.

In the embodiment illustrated in FIG. 10, the distance the tether moves during the crosswind power generating phase is greatly reduced, which enables intermediate energy capture options between the aerodynamic device and the ground drum winching device. For example, an intermediate energy capture device may be dedicated to capturing the higher crosswind power phase energy while a drum based ground winching device is designed around the lower load requirements of the glide back and simple pull out phase. With a shorter power generating phase, the section of the tether that wraps the ground winching drum or intermediate energy capture device while the aerodynamic device is in the shortened crosswind power phase could be specially designed with increased fatigue strength and heat resistance resulting from nominal tether tension stress (that the whole exposed tether from the drum to the aerodynamic device experiences) plus handle the additional bending stress and heat generation from being wrapped around the ground winching drum or intermediate energy capture device. The design requirements for such tether section may include, for example, increasing the tether diameter or changing the tether cross section to reduce bending stresses while increasing load carrying capacity.

FIG. 3 illustrates a predetermined flight path of an aerodynamic device following a flight path having zigzag pattern. As shown, the X-axis, Y-axis, and Z-axis are perpendicular to each other. The X-axis and Y-axis form a plane parallel to ground level. The Z-axis refers to a vertical axis. The terms “range of flight” and “range of flight path” refers to a range of distance along the Z-axis (altitude) that the disclosed device requires to perform a turn, in this case a complete 180 degree turn around the pitch axis of the aerodynamic device. The flight path may also have a range of flight in the width of the flight path. A nominal tether position is indicated referring to an average position of the tether during the crosswind power generating phase. It is understood that during the flight the actual tether is coupled to the aerodynamic device. An angle θ_{zig} indicates the angle between ground level and the tether nominal flight path, ranging between about 20 degrees and about 50 degrees.

The wind energy conversion cycle starts with a release phase wherein the aerodynamic device leaves the tower, drifts straight out away from the wind, for example in a simple kite mode, with the side wings being substantially parallel to the ground (no turning). This move is only done once during launch of the device and once during retrieval of the device (for example during excessively high winds, no wind, or maintenance). The length of this cycle depends on the size of the wing and of the flight pattern, which determines the range of the flight path.

After the device is launched from its ground station, for example provided with a tower, the tether is let out in a controlled manner while the device is acting as an “into the wind” energy generating system. A suitable tether release speed would be about 1/3 of the wind speed. A minimum tether length is released from the winching device at the ground station before the wing can begin its first flight maneuver. The minimum tether length ensures there is adequate ground clearance, with a safety margin, at the bottom of the maneuver to the wing tip (see for example FIG. 4).

The next phase of the wind energy conversion cycle is a crosswind power generating phase, wherein the zigzag power mode starts when the wing can turn crosswind and begin the zigzag pattern with assurance that the bottom wing tip would clear the ground with some safety margin. For example, data from various sensors may be analyzed to determine the wing's position and performance, and flight control systems may adjust surface controls to keep the wing flying along a pre-determined path with the optimum amount of lift force. The aerodynamic device follows a crosswind flight path in a plane that is substantially perpendicular to the tether or at a small angle relative to the tether (such as less than 10 degrees caused by variation in the flight control system that would be targeting a perpendicular angle). During this phase the wing is actively pulling the tether.

The crosswind flight path may include a plurality of turns, and at each turn the airborne wing flips around an axis, for example the pitch axis, i.e., an axis of the airborne wing that is perpendicular to a direction of flight of the airborne wing and perpendicular to the tether. See for example FIGS. 2 and 3 showing the respective axes relative to the orientation of airborne wing 102. The body of airborne wing 102 further has a lateral axis, longitudinal axis, and a vertical axis. The lateral axis of airborne wing 102 corresponds with its pitch axis, and the longitudinal axis corresponds with the direction of flight axis of airborne wing 102. In other words, the aerodynamic device approaches a turn with one side of the device facing the tether, turns around the pitch axis of the aerodynamic device, and continues the flight path in an opposite flight direction with the opposing side of the aerodynamic device facing the tether. The aerodynamic device climbs to a slightly higher altitude until the control system directs the device to make another turn in the opposite direction.

It is understood that the control system directs the aerodynamic device to make the appropriate turn by adjusting an angle of attack on the front and rear side wings, for example by steering control surfaces and/or rudders. During the power generating phase, a turn direction alternates in opposite directions, at predetermined time intervals or at predetermined distances, to accomplish the zigzag pattern. Predetermined time intervals can be constant time intervals, time intervals following a specific pattern, or time intervals adapted to flight circumstances, such as wind force or rain. In some embodiments, turns may be accomplished at predetermined distances, for example with the assistance of a GPS.

The crosswind flight pattern of the disclosed aerodynamic device contrasts to crosswind flight paths followed by conventional devices. Known devices are limited by the large turn radius that is required to make the device turn around a tether axis when following a FIG. 8 flight path. In such a flight pattern, a range of flight path along the Z-axis (range of flight in altitude) required to perform a turn, equals about 6 times the length of the wingspan of the known device. Similarly, a range of a flight path along the Y-axis requires more than 6 times the length of the wingspan of the known device following a FIG. 8 pattern. The large turn radius of known devices affects the performance of conventional systems because known devices with a large wingspan produce significantly less average power than the devices disclosed herein.

In some embodiments, the nominal position, i.e., the theoretical average position, of the tether during the power generating phase as used with the aerodynamic device may range between about 20 degrees and about 50 degrees off the ground, for example about 30 degrees.

FIG. 4 illustrates that the power generating phase starts at a predetermined height and ends at a predetermined height. The predetermined start height relates to the wingspan of the airborne wing, as explained above, so that the airborne wing has enough clearance to make the directed turns. For example, a start height for the crosswind power generating mode for a wing with a wingspan of about 80 feet, tower height and ground safety margin of about 30 feet and nominal tether angle of about 30 degrees, would be after releasing about 69 feet of tether in the disclosed device whereas it would require about 415 feet of a tether in conventional systems.

At the end of the power generating phase, a maximum tether length released from the ground system ensures that the wing tip during its maneuver does not exceed a given height restriction, with a safety margin on the top side, of the maneuver. The zigzag pattern ends when the top wing tips reach upper height limitations, for example a maximum height imposed by the FAA, such as about 499 feet above ground level, minus some safety margin, for example of about 30 feet (see for example FIG. 4). The end height for the crosswind power generating mode would be reached after releasing about 808 feet of tether in the disclosed device, whereas it would be about 462 feet of tether in conventional systems. Assuming the tether tension is the same, the disclosed device would generate power over a distance about 739 feet (808-69 feet), whereas the conventional device would generate power over a distance of about 47 feet (462-415 feet) only.

Generally, power generation (performance) in an aerodynamic device is a function of the aircraft and tether weight, the airfoil lift and drag coefficient, air density, relative velocity squared and a linear factor of the overall wing planform area (wing chord times wingspan for a rectangular wing). Assuming a constant chord, increasing a wingspan results in the same increase in lift and drag force. However given the limited range of flight outlined in FIG. 4 (height tops out at the current FAA height limit of 499 feet above ground level in the United States), increasing wingspan reduces the length of time in the crosswind power production cycle (tether length released from the start height to the end height). The glide back phase timing is a based on the distance flown in the power generating cycle. The time to turn the aerodynamic device into the glide and power phase is going to be roughly constant. With increasing wingspan the turn-to-glide phase and turn-to-power phase become a large portion of the overall flight time to complete one cycle. So the crosswind power generating phase becomes a smaller and smaller portion of the overall cycle time with increasing wing span due to the fixed overhead time taken in the turns. The length of the power generating phase depends, inter alia, on the wing size, flight pattern which determines the range of the flight path, and length of the tether. During the power generating phase, the wing tips are generally pointed to the sky and at the other end, generally pointed to the ground, and airborne wing 102 moves at an angle to the vertical plane corresponding to the nominal tether angle.

In the subsequent phase of the wind energy conversion cycle, the device turns to glide mode, i.e., upon completing the zigzag pattern, the wing rolls 90 degrees and yaws 90 degrees. The time required to complete this maneuver is a fixed time for a particular device.

Following the turn phase is a glide back phase, i.e., the airborne wing glides back towards the tower when the wing's angle of attack is reduced. The wing glides substantially parallel to the ground or tower platform. The glide back time is proportional to the tether release distance in the power generating mode. In other example embodiments, the aerodynamic device may glide back with its side wings perpendicular to the ground to eliminate the 90 degree roll turn before the start and end of the glide back mode. Lift in this embodiment of the glide back flight mode may be provided by the rudders at the end of the front and rear side wings.

The energy conversion cycle ends with a turn-to-power phase. Similar to urn-to-glide, the wing rolls 90 degrees and yaws 90 degrees, before a new cycle can start.

FIG. 8 shows a graph illustrating the power generated during different phases for an airborne wing with a wingspan of about 80 feet and following a zig-zag flight path during a power generating phase.

In another example embodiment including two sets of side wings, an aerodynamic device having a wingspan of about 48 feet could create an average power output of 200 kW under ideal conditions.

One of the general goals of wind energy conversion systems is to maximize power generation for a given space of land or water. For example, in many areas, the land directly under the system flight path is owned by a system operator or property rights are given to a system operator. Maximizing power generation may be accomplished by maximizing the wing area. Additionally, it is desirable to have a wing with a high aspect ratio, i.e., a ratio of the length of the wing to the breadth of the wing, to maximize the wing's aerodynamic efficiency. Furthermore, the turn radius required for conventional crosswind flight maneuvers, such a circle or FIG. 8 pattern, can be up to three times the wingspan from a turn center (nominal position of the tether) to the farthest wing tip. Thus, with conventional systems the crosswind power generating phase becomes shorter with increasing wingspan because the turn radius required for known devices is about three times the wingspan of these devices. In contrast, the inventive subject matter is directed to an airborne device that minimizes the vertical airspace required by making turns around an axis normal to the tether.

According to the disclosed embodiments, an aerodynamic device having an open tail design with a tether attachment near the center of aerodynamic lift and weight, allows the device to make alternating turns of approximately 180 degrees around the pitch axis when directed by a control system. Combined with a uniform tether release speed, the alternating flips of the device result in a zigzag flight pattern. This zigzag flight pattern uses significantly less vertical airspace than known systems and increases that amount of tether released in the power generating phase.

Furthermore, using two sets of side wings (front and rear) of equal wingspan and offset slightly perpendicular to the direction of travel to minimize front to rear wing air turbulence, such as the device shown in FIGS. 1 and 2, may have 30% more lift area than a conventional design, such as one using a large front wing and much smaller tail elevator wing.

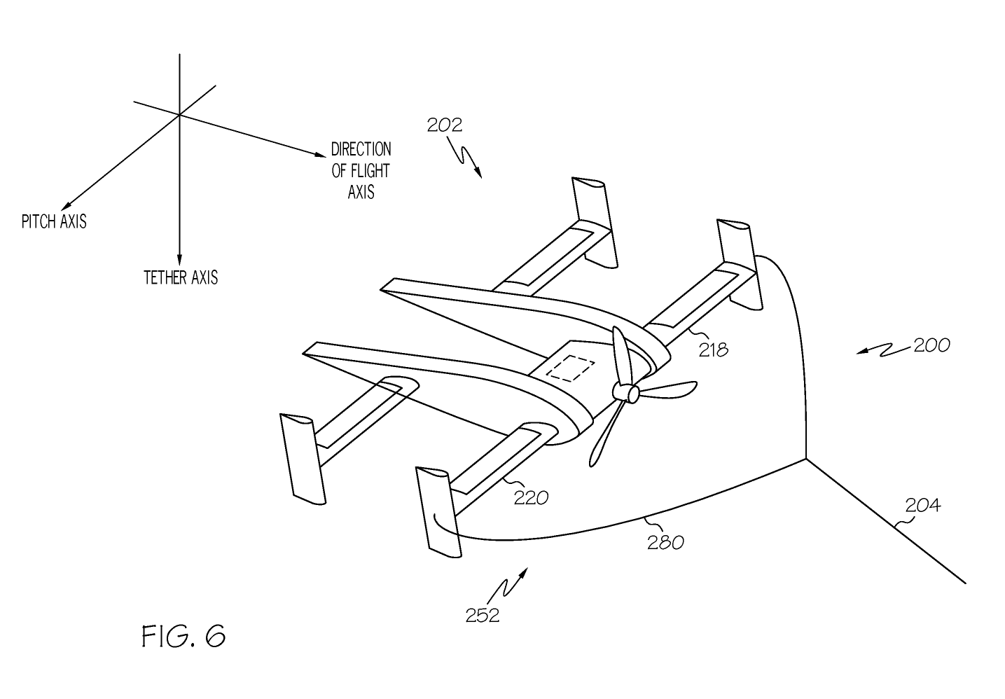

Turning attention to FIG. 6, a second example of a wind energy conversion system 200 will now be described. System 200 includes many similar or identical features to system 100. Thus, for the sake of brevity, each feature of system 200 will not be redundantly explained. Rather, key distinctions between system 200 and system 100 will be described in detail and the reader should reference the discussion above for features substantially similar between the two systems.

As can be seen in FIG. 6, system 200 includes an airborne wing 202 and a tether 204. System 200 further includes a generator and a control system similar as described above. A key distinction however is that coupling mechanism 252 includes a loop element 280 that is coupled to wing tips of opposing front wings 218 and 220, and to tether 204 so that loop element 280 allows the device to turn around freely around the pitch axis. This changes the loading on the side wing to have two end constraints (tether attachment points) with an opposing uniformly distributed aerodynamic lift force. In some embodiments, a wing design different from the ones described above may be contemplated. In further embodiments, a loop element configuration may allow multiple wing systems to be stacked on a single tether.

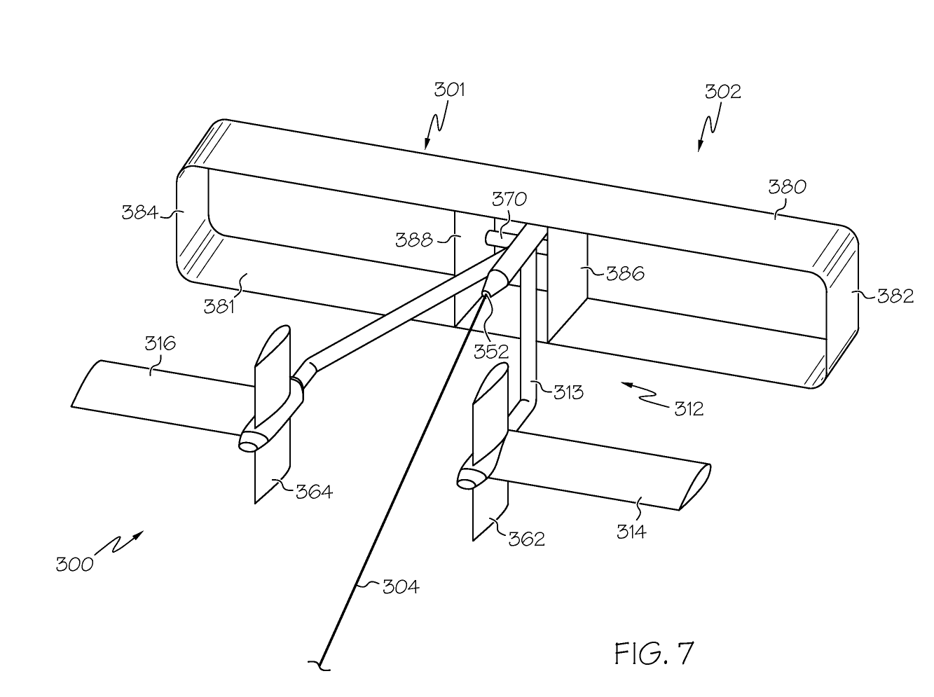

Turning attention to FIG. 7, a third example of a wind energy conversion system 300 will now be described. System 300 includes many similar or identical features to system 100. Thus, for the sake of brevity, each feature of system 300 will not be redundantly explained. Rather, key distinctions between system 300 and system 100 will be described in detail and the reader should reference the discussion above for features substantially similar between the two systems.

System 300 includes an airborne wing 302, including a body 312 and a tether 304. The system further includes a generator and a control system similar as described above. A key distinction however is that airborne wing 302 includes a single front bi-wing 301 formed as a continuous structure composed of side rudders 382 and 384 and main wings 380 and 381 coupled to the front of frame 313. Two side wings 314 and 316 may be coupled to frame 313 at the back of V-shaped frame 313, and form the back wings. Wings 314 and 316 are each provided with rudders 362 and 364. A coupling mechanism 352, allowing tether attachment, is provided to frame 313. A pivoting shaft 370 and an open ended frame 313 allow rotation of single front wing 301 around a pitch axis of the airborne wing 302. The open back end of frame 313 allows tether 304 to pass freely during the zigzag turns.

Front bi-wing 301 includes support rudder elements 382 and 384 at side ends of front wing 301. Additional support elements 386, 388, each positioned equidistant, left and right, to a mid-wing position are coupled to pivoting shaft 370 of bi-wing 301. In some embodiments, support rudder elements 382 and 384 may be vertical support airfoils including moving parts serving as rudders at the outer ends of front bi-wing 301. For example, support elements including pivotable surface may allow airborne wing 302 to turn slightly (up to 12 degrees) about the yaw axis during the crosswind power generating mode and generate lift away from the ground. In other examples, support elements may be fixed (non-movable) to front wing 380.

The embodiment shown in FIG. 7 has the advantage that only one control system is needed to flip the bi-wing 301. In some embodiments, front bi-wing 301 can pivot at shaft 370, for example, at approximately 25% back from the leading edge of the wing, to minimize the power required to turn the wing.

In similar embodiments, the front bi-wing assembly 301 maybe fixed to frame 313 with movable control surfaces added inside either the top main wing 380 or bottom wing 381 to enable device movement around the pitch and roll axes. The rudders 382 and 384 would be movable in this configuration. The bi-wing assembly provides a stronger box wing construction and provides additional lift area and device maneuverability in a given wing span. In another embodiment, the bi-wing configuration could be utilized at the rear of the device to replace the single wings 314 and 316. This device embodiment could be utilized in a zigzag, FIG. 8 or circular flight pattern.

The energy production of the systems described herein shows an exponential increase with increasing wingspan of the aerodynamic device. This occurs because the zigzag pattern enables the power generating phase to begin earlier (e.g., wing tip clears the ground with a safety factor) and ends later (e.g., wing tip is below the FAA height limit with a margin of safety). For example, a system including two sets of about 20 ft wingspan, each with an aspect ratio of about 10, corresponds to an energy production ranging between about 40 kW and about 80 kW, or approximately 0.5 to 1.0 kW per square foot of wing planform, including some loss of lift area for example resulting from the open tail 150 in FIG. 2. In contrast, when the wingspan increases in conventional systems, the energy production remains relatively constant.

Furthermore, systems according to the inventive subject matter show an exponential increase in energy production per unit of land with increasing wingspan whereas with conventional systems the energy production per unit of land remains relatively constant. In embodiments according to the inventive subject matter, an increase in the nominal tether angle increases the energy production per unit of land area in a wind farm application.

Additionally, an increase in wingspan of a conventional device following a circular flight path results in a significant decline in average power produced. For example a drop from about 58% for an wingspan of 10 feet to about 30% for a wingspan of 80 feet. In contrast, power produced by a zigzag pattern accomplished with the disclosed device results in no significant decline in average power production with increasing wingspan.

Increasing the wingspan of an aerodynamic device increases an overall zigzag average power. For example, the zigzag power mode starts later for a device with a wingspan of 80 feet compared to the start of the zigzag power mode for a device with a wingspan of 10 feet (which is why simple power mode duration is higher). The zigzag power mode for a device with wingspan 80 ends earlier than the zigzag power mode for a device with wingspan 10 because of space needed for maneuvering the increased wingspan. The glide back power is a ratio of the power generated in the crosswind power generating phase. In both cases the turn to glide time and turn to power time is the same.

The inventive subject matter further contemplates a method for optimizing wind farm layout by providing a plurality of wind energy conversion systems, for example as described above. The airborne wing of each of the plurality of wind energy conversion systems includes a predetermined wingspan and a predetermined turn radius. A minimum spacing between the towers of the plurality of wind energy conversion systems is based on the wingspan and the turn radius of the airborne wing. The wind energy conversion systems are arranged in a layout that optimizes land usage. In some embodiments, control systems may coordinate with each other to achieve optimal results. In other embodiments, airborne wings may be provided with one or more rudders to adjust the flight path of the airborne wing and to increase a nominal tether angle, and by balancing lift and drag moments of the rudders, plus a wing weight moment, around a tether attachment point in a crosswind power generating mode around a yaw axis of the airborne wing. In these embodiments, the density of wind energy conversion systems in a wind farm layout increases.

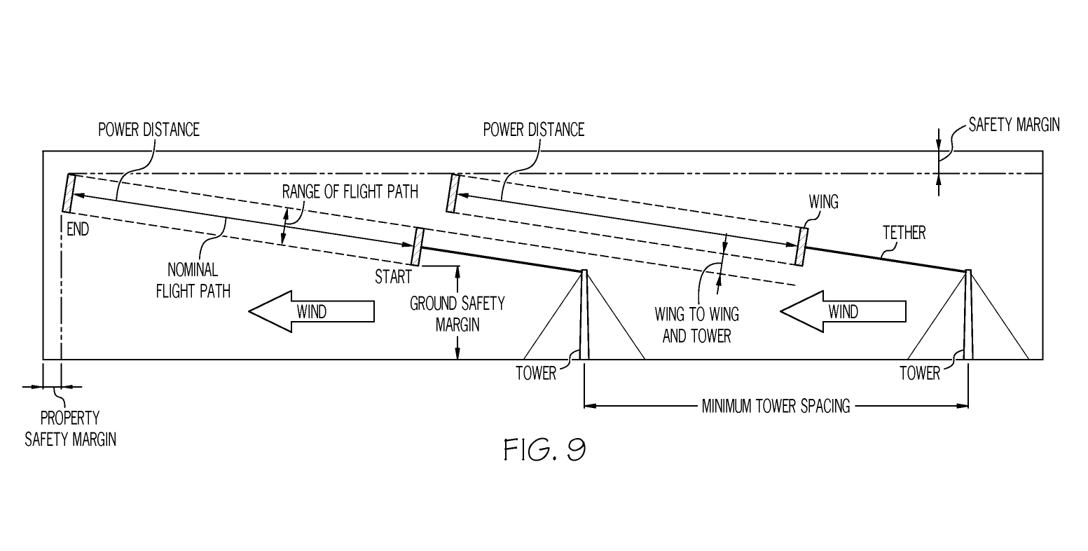

FIG. 9 shows an example of a layout for a wind farm using a plurality of the above described systems and devices. Individual systems may operate autonomously or in coordination with neighboring systems. In some embodiments, for example using aerodynamic devices having a wingspan of about 10 feet, a tower height of 30 feet, and a 30 degree nominal tether angle, may have a minimum tower spacing of about 80 feet, whereas a conventional system with similar dimensions would require about 180 feet. Tower spacing is such that the range of the flight path of a device tethered to the upstream tower, clears the range of the flight path of a device tethered to the downstream device by a wing-to-wing safety margin.

The more compact layout achieved by using the disclosed systems results in reduced land usage while increasing power production and maintaining safety clearance distances. In other words, a reduction in the vertical and horizontal airspace required to make the zigzag power generating maneuver versus traditional circles or figures, results in a reduction of the projected land usage below (enabling greater packing density of energy generating systems) and an increase of the energy production (lift force can be applied over a longer tether release distance).

Additional advantages of the disclosed systems include small and portable technology (for example some embodiments may weigh less than 50 lb), and launch and retrieval when needed.

Another advantage of the disclosed systems is in the event of an unexpected loss of flight control, broken tether or other system failure which would most likely send the fast flying aerodynamic device off in a direction basically parallel to the ground due to mechanical momentum versus potentially directed at the ground in devices with circular or FIG. 8 flight patterns. Sending the device off parallel to ground allows for additional time to react and automatically activate back-up control systems, parachute or airbag to cushion the ground impact or bring the aerodynamic device down in a more controlled fashion.

Other applications of devices and systems according to the inventive subject matter may include sporting kites, such as used for wind surfing or ski surfing. Further applications may include systems that form a driving energy source for an engine-less transport wing system where the driven device could be a balloon or an airborne craft where the angle of attack is controlled to add a drag force that is necessary for the disclosed device to generate maximum propulsion power to the driven device.

The specific embodiments disclosed and illustrated above are not to be considered in a limiting sense as numerous variations are possible. The subject matter of the inventions includes all novel and non-obvious combinations and sub-combinations of the various elements, features, functions and/or properties disclosed above and inherent to those skilled in the art pertaining to such inventions.

Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and sub-combinations of the disclosed inventions that are believed to be novel and non-obvious. Inventions embodied in other combinations and sub-combinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

All patent and non-patent literature cited herein is hereby incorporated by references in its entirety for all purposes.

What is claimed is:

1. A wind energy conversion system, comprising:
an airborne wing;
a tether having an upper end coupled to the airborne wing and a lower end coupled to a winching device;
a generator coupled to the tether via the winching device;
a control system arranged to communicate with the airborne wing so that the control system directs the airborne wing to follow a predetermined flight path including a power generating phase; and
wherein the predetermined flight path, during the power generating phase, includes a crosswind flight path of increasing altitude and having a plurality of airborne wing turns, at each turn the airborne wing flips around an axis of the airborne wing, so that a vertical airspace for the predetermined flight path during the power generating phase is minimized.

2. The system of claim 1, wherein the airborne wing further comprises a portion facing the tether and a portion facing away from the tether, and at each turn the airborne wing flips around the axis so that the portion facing the tether before a turn faces away from the tether after the turn and the portion facing away from the tether before the turn faces the tether after the turn.

3. The system of claim 1, wherein the axis of the airborne wing during the power generating phase is perpendicular to a direction of flight of the airborne wing and perpendicular to the tether.

4. The system of claim 1, wherein the power generating phase starts at a predetermined height and ends at a predetermined height.

5. The system of claim 4, wherein the end height is about 499 feet above ground level.

6. The system of claim 1, wherein the control system directs a uniform release speed of the tether during the power generating phase.

7. The system of claim 1, wherein the control system includes an onboard control system of the airborne wing.

8. An aerodynamic device, comprising:
a body including a frame and two or more side wings coupled to the frame;
a coupling mechanism coupled to the body and arranged to couple the body to a tether; and
wherein the body is adapted to perform a flight path including a plurality of turns so that during each turn the body of the device rotates about 180 degrees around an axis of the device and the coupling mechanism allows the body to rotate freely relative to the tether.

9. The device of claim 8, wherein the frame includes two arms and a passageway between the two arms that allows the tether to pass freely between the arms when the body flips around the axis.

10. The device of claim 8, wherein the coupling mechanism is arranged to allow coupling of the tether near a center of aerodynamic lift and near a center of gravity of the device.

11. The device of claim 8, further comprising a control system arranged to direct the aerodynamic device to follow a predetermined flight path including a power generating phase.

12. The device of claim 8, wherein the two or more side wings comprise a one-piece wing structure at a leading edge of the body.

13. An aerodynamic device, comprising:
a body including a frame and two or more side wings coupled to the frame;
a coupling mechanism coupled to the body and arranged to couple the body to a tether; and
two or more rudders arranged to generate lift away or towards the ground and configured such that a total lift of the rudders adjusts a flight path of the device by changing a nominal tether angle during a crosswind power generating phase.

14. The device of claim 13, wherein a sum of rudder lift and drag moments plus a weight moment of the aerodynamic device, are balanced around a tether attachment point in a crosswind power generating phase when the two or more rudders are approximately turned equal amounts around a yaw axis.

15. The device of claim 13, further comprising two or more control surfaces incorporated in the two or more side wings and arranged to assist in turning of the device.

16. The device of claim 13, wherein the coupling mechanism includes a loop element that is coupled to the tether and to opposing wing tips of the two or more side wings, and wherein the loop element is arranged to allow the body and the two or more side wings to pass through the loop element when the device flips around an axis of the device.

17. The device of claim 13, wherein the device has a predetermined wingspan and wherein the rudders are adapted to direct the device to follow a flight path having a range of flight that is smaller than about six times the predetermined wingspan.

18. The device of claim 13, wherein the two or more side wings comprise at least one rudder.

19. The device of claim 13, wherein the two or more side wings are stacked vertically and comprise one or more support elements including at least one rudder.

20. The device of claim 13, wherein the two or more rudders are adapted to rotate the body of the device around an axis of the device during the power generating phase.
